(19) United States
(12) Patent Application Publication
(10) Pub. No.: US 2014/0129545 A1
(43) Pub. Date: May 8, 2014

(54) SORTING SEARCH RESULTS

(71) Applicant: Google Inc., Mountain View, CA (US)

(72) Inventors: Ullas Gargi, Sunnyvale, CA (US); Richard Gossweiler, Sunnyvale, CA (US)

(73) Assignee: Google Inc., Mountain View, CA (US)

(21) Appl. No.: 13/668,187

(22) Filed: Nov. 2, 2012

(51) Int. Cl. G06F 17/30

(52) U.S. Cl. 707/722; 707/E17.082

(57) ABSTRACT

A system and method is disclosed for organizing search results in response to a search query. A search query and sorting criteria are received from a web browser, the sorting criteria including a coarse level of granularity and a fine level of granularity. Results are received from a search engine based on the search query and the search results are organized based on the multiple sorting criteria. In this regard, the search results are ordered top-down from the coarse level of granularity to the fine level of a granularity. The organized search results are then provided for display to the web browser.

### BACKGROUND

The subject technology relates generally to search engines. Search engines crawl websites, and store data about web pages in an index database for use in later search queries. When a user enters a query into the search engine, the engine examines its index and returns a listing of best-matching web pages to the user according to a predetermined criteria.

### SUMMARY

The subject technology provides a system and method for organizing search results in response to a search query (for example, through chunked sorting). According to one aspect, a computer-implemented method may comprise receiving a search query and one or more criteria for organizing search results, and returning a plurality of search result sets organized according to a first received criteria, a respective search result set including a listing of resources responsive to a subject matter of the search query and organized according to one or more second criteria. Other aspects include corresponding systems, apparatus, and computer program products.

The previously described aspects and other aspects may include one or more of the following features. For example, the search result set may include a plurality of search result subsets, a search result subset including search results organized according to a third received criteria. The first received criteria may be a user-provided level of granularity that divides a group of search results returned in response to the search query, the group of search results comprising the search results of the returned search result sets. In this regard, the user-provided level of granularity may be a time-based granularity, the group of search results being divided by a time period associated with the time-based granularity, the returned search result sets being returned for respective time periods and ordered by time.

The second criteria may be received with the first received criteria. In this respect, the one or more second criteria comprises an instruction to sort the respective search result set according to a relevance of the search results to a user of a web browser. Additionally, for a respective search result in the search result set, the relevance may be based on a degree of relationship between subject matter of the respective search result and a past browsing history of the user. For a respective search result in the search result set, the relevance may be based on a distance of the user from a geographic location associated with the respective search result. For a respective search result in the search result set, the relevance may be based on a difference between a current time and a time associated with a subject matter of the respective search result.

Additionally or in the alternative, the first received criteria may be a geographic level of granularity, with the method further comprising displaying at least one of the plurality of search result sets graphically on a map, a search result set displayed for a respective geographic boundary determined by the level of geographic granularity. Additionally or in the alternative, the method may further comprise determining a group of search results, the group of search results comprising the search results of the returned search result sets, determining the one or more criteria based on the determined group of search results, and providing the multiple criteria to a search engine. The method may further comprise providing a search interface to a user, the search interface including an input for receiving the search query and one or more controls for selecting the one or more criteria.

In another aspect, a machine-readable medium may have instructions stored thereon that, when executed, cause a machine to perform a method for organizing search results in response to a search query. In this regard, the method may comprise sending a search query and one or more sorting criteria, receiving a group of search results based on the search query, organizing the search results based on the one or more sorting criteria, and providing a search result page for display, including the organized search results. Other aspects include corresponding systems, apparatus, and computer program products.

The previously described aspects and other aspects may include one or more of the following features. For example, the method may further comprise receiving a coarse level of granularity and a fine level of granularity, organizing the group of search results into search result sets ordered top-down from the coarse level of granularity to the fine level of a granularity. The method may further comprise receiving a first sorting criteria and a second sorting criteria from the web browser, dividing the group of search results into a plurality of search result sets based on the first sorting criteria, and organizing a search result set based on the second sorting criteria. The method may further comprise comparing the search result set to a past browsing history, the search result set being organized based on a degree of relationship between subject matter of respective search results in the search result set and the past browsing history.

The search result set may be ordered based on a distance of the user from a geographic location associated with the search result. The search result set may be ordered based on a difference between times associated with a subject matter of the search results. Additionally or in the alternative, first received criteria may be a geographic granularity, the method further comprising providing the plurality of search result sets for graphical display on a map, a search result set displayed for a respective geographic boundary determined by a level of the geographic granularity.

In a further aspect, a system may include one or more processors, and a memory. The memory may include server instructions thereon that, when executed, cause the one or more processors to receive a search query and sorting criteria, the sorting criteria comprising a coarse level of granularity and a fine level of granularity, receive search results based on the search query, organize the search results based on the multiple sorting criteria so that the search results are ordered top-down from the coarse level of granularity to the fine level of a granularity, and provide a search result page for display, including the organized search results.

These and other aspects may provide one or more of the following advantages. The subject technology provides searched-for information in a format that is specifically tailored to a user. By organizing search results in an expected format for the user, the user may more easily find information, and is saved cognitive resources measured in the effort and time that would otherwise be required to sort through a list of search results not tailored to the user's liking. Accordingly, the user has more time to perform other tasks or activities within, or unrelated to, the realm of searching for information.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 is a diagram of example components for organizing search results in response to a search query.

FIG. 2 is a first example diagram of a web browser, including a toolbar, including one or more inputs for receiving a search query and sorting criteria.

FIG. 3 is a flowchart illustrating an example process for organizing search results in response to a search query.

FIG. 4 is an example diagram illustrating server and database components of a system for organizing search results in response to a search query.

FIG. 5 is a diagram illustrating an example server system for organizing search results in response to a search query, including a processor and other internal components.

### DETAILED DESCRIPTION

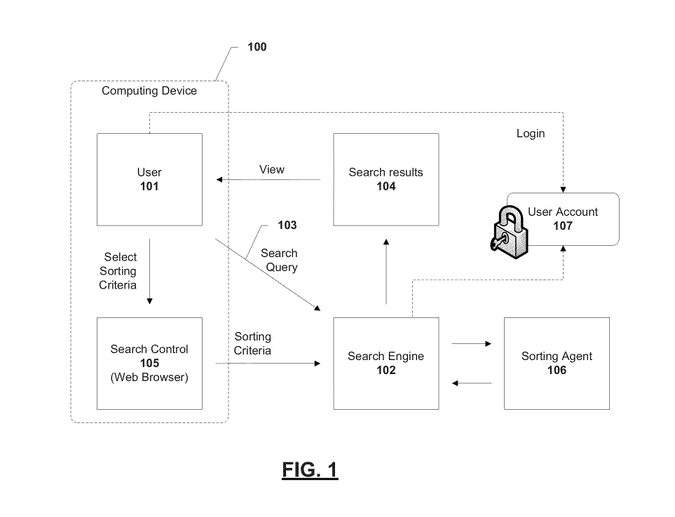

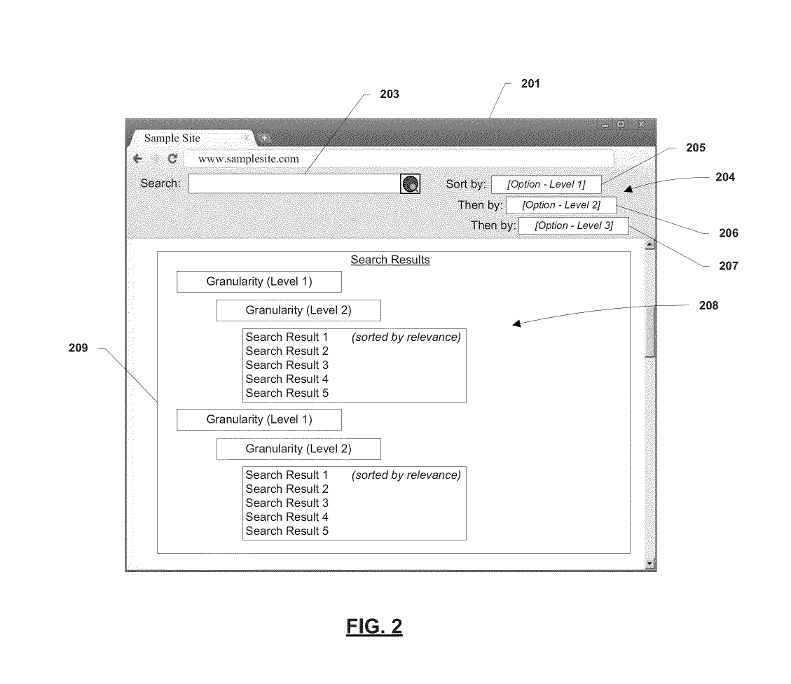

FIG. 1 is a diagram of example components for organizing search results in response to a search query according to one aspect of the subject technology. A computing device 100 (for example, a smartphone, GPS navigation device, or personal computer, tablet computer, PDA, a television or other display device with one or more location-aware computing devices embedded therein or attached thereto) includes a web browser. A user 101 accesses, using the web browser, a search engine 102 over a network (for example, a WAN, LAN, Internet, or the like), inputs a search query 103 and receives search results 104 in response to the search query. Search engine 102 may provide a search engine interface displayed as one or more web pages on the web browser for interacting with search engine 102. For example, search engine 102 may provide one or more web pages (FIG. 2) for receiving search query 103 and displaying search results.

In various aspects, a search control 105 is provided for organization of search results 104. Search control 105 may be provided as part of a web page, script, or other web component provided by search engine 102 in connection with providing the search interface to user 101. In some aspects, search control 105 may be a browser component, integrated with the web browser. Using search control 105, user 101 may enter predetermined sorting criteria for how search results 104 are to be displayed. For example, user 101 may enter a sorting criteria, including a level of granularity for further organization of sorted results based on, for example, time, geographic area, or the like.

When search query 103 is input and committed at the search interface, search engine 102 receives, along with search query 103, the predetermined criteria generated from search control 105. In implementations where search control 105 is part of the search engine interface, the predetermined sorting criteria may be processed with search query 103 as a single operation. In implementations where search control is a separate component (for example, integrated with the web browser), the predetermined sorting criteria may be sent asynchronously to search engine 102 in connection with committing search query 103 at the search interface.

Search engine 102, on receiving search query 103 and criteria for organizing the search result, returns a plurality of search results 104, organized according to a received criteria. In one example implementation, search engine 102 works in connection with a sorting agent 106. Sorting agent 106 includes software instructions for carrying out sorting and organization of search results 104 according to the received criteria. Search agent 106 may be separate from search engine 102, receive search results 104 from search engine 102, and then perform sorting and organization of search results 104 before they are returned to search engine 102 and/or user 101. In other aspects, search agent 106 may be integrated with search engine 102, and operate to cause search engine 102 to retrieve portioned search result sets based on an organization scheme defined by the received sorting criteria.

Additionally or in the alternative, the user may authorize the system to allow remote storage of a predetermined sorting criteria on a central server (for example, in a data cloud). In this respect, user 101 enters sorting criteria at a user interface (for example, at the previously described search interface or web browser component) and the sorting criteria is stored in connection with a user account 107 associated with the user. The sorting criteria is stored such that it is accessible only by the user, or the subject technology, when the user is authenticated (signed in) to the user account.

FIG. 2 is a first example diagram of a web browser 201, including a toolbar 202 (for example, as HTML, a butter bar in a webpage, or the like), including one or more inputs for receiving a search query and sorting criteria according to one aspect of the subject technology. In the depicted example, toolbar 202 includes a search input 203 and multiple sorting controls 204 for input of multiple respective levels of sorting criteria. A search engine provides chunked sorting of search results in response to a search query entered at search input 203. In one aspect, one or more criteria are selected from sorting controls 204 before the search query is submitted by the user. One or more of the sorting controls 204 may include selection of one or more levels of granularity (for example, based on time, geographic area, or the like) for organizing search results into sets of search results according to a selected level of granularity. Where multiple controls 204 are provided, the user may use each subsequent control 204 to select a respective level of granularity, for example, from a coarse level to a fine level. Multiple levels of criteria may be selected to group and/or sort the returned results.

A search that includes multiple selected sorting criteria will result in multiple respective levels of search result sets. Each top-level search result set may include a plurality of search result subsets, and each subset may include further result subsets. In the depicted example, the search engine, on receiving the search query and a first criteria 205, second criteria 206, and third criteria 207, returns search results as a plurality of search result sets 208, organized according to the received criteria. First received criteria 205 divides a group of search results returned by the search engine into one or multiple first search result sets in response to the search query. In this regard, each first search result set includes search results grouped by a first level of granularity. Second received criteria 206 further divides each first search result set that is returned into one or multiple second search result sets, grouped by a second level of granularity, and so on. The last selected level of granularity may further group the penultimate set or subset into further subsets, or may merely sort the results of the set or subset. For example, in FIG. 2, third received criteria 207 sorts each search result set returned for a respective second level of granularity. In some implementations, each search result set or subset are limited to a predetermined number of results. For example, each search result set may include a maximum of five subsets, with each subset including a maximum of five search results.

The previously described sorting criteria may group or sort search results. If the criteria is a level of granularity, the plurality of search result sets for that criteria may be grouped based on that level of granularity. For example, if the level of granularity is a time-based granularity, a sorting control 204 for selection of the level of granularity may include selections for “days,” “weeks,” “months,” or the like. Accordingly, the group of search results returned in response to a search query are divided by a time period of the level of granularity, and ordered according to the respective time period intervals for that level of granularity. If a sorting control 204 is for a geographic granularity, the control may include selections for “city,” “county,” “state,” or the like. In this implementation, the search results returned for the level of granularity may be divided according to geographic area. For example, search results may be grouped using a coarse level of granularity by state. Another sorting control 204 may correspond to a fine level of granularity that further groups search results returned for each state by city or county.

In some aspects, search results for a set of search results may be organized (for example, sorted or ordered) according to their relevance to the user. For a particular set of search results, the search results may be ordered by normal relevance and ranking (for example, quality ranking) as determined by the search engine. For example, given the search query “elections” determined from a search query, and a sorting time with a granularity of weeks, search results for each week may be sorted according to the default method of the search engine. In some examples, a search result set may be compared to a past browsing history (for example, stored locally on computing device 100 or in connection with the web browser, stored at a remote location associated with user account 107, or the like), and organized based on a degree of relationship between subject matter of respective search results in the search result set and the past browsing history.

Additionally or in the alternative, the search result set may be ordered based on a distance of the user from a geographic location associated with the search result. The search result set may be ordered based on a difference between times associated with the subject matter of the search results. For example, ordering may be from a publication time of the subject matter, or from a current time. If a user searches for news stories on a hurricane, search results may be returned based on the publication dates of a news article associated with each search result.

In some aspects, search results 208 may be returned as representations on a map. When organized by a level of granularity based on geographic area, for example, using the previously described sorting controls 204, each search result set may be associated with a respective geographic boundary determined by the level of granularity. The search result sets may then be displayed at their respective geographic locations on the map. For example, a map may include a marker displayed on the map at a geographic location corresponding to each city that returned search results. A search result set may be presented (for example, in a pop up window, dialogue, another part of the host webpage, or the like) on selection of the marker.

In some aspects, sorting criteria, including levels of granularities, may not be provided by the user performing the search. For example, a level of granularity may be passed by a cookie at logon, based on a predetermined indicator. For example, the level of granularity may be selected based on a GPS location provided by a mobile device, based on an IP address of the user, or based on a date viewed on a calendar, or location viewed on an interactive map. In one example, the search engine returning the search results to the user may analyze a larger set of search results returned for the search query, and then automatically determine one or more levels of granularities from information (for example, meta data) returned in the search result. These determined granularities may then be recommended to the user as selectable options for sorting the returned results. In other aspects, a level of granularity determined by the search engine may automatically be applied based on the content of a search result.

Search results 208 may be automatically updated as a search query is updated at toolbar 201 or a criteria is updated at a sorting control 204. For example, when a portion of a query is received at toolbar 201, the search engine may process that portion and return corresponding search results browser 201 in real-time. A result page 209 may further be configured to allow navigation of search results 208 using a scroll bar 210 or via a paged display.

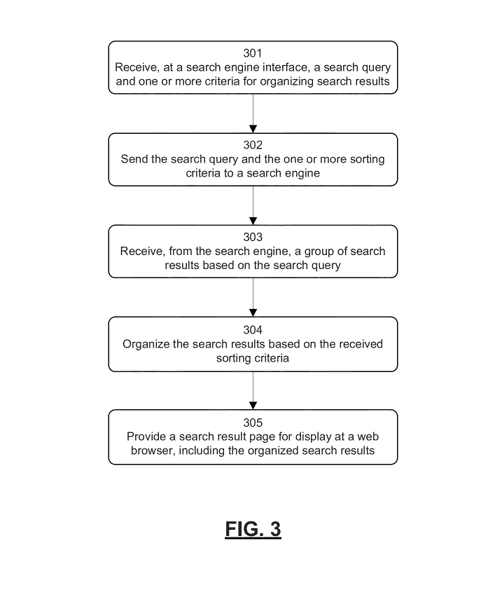

FIG. 3 is a flowchart illustrating an example process for organizing search results in response to a search query according to one aspect of the subject technology. According to some aspects, the blocks of FIG. 3 may be executed by one or more computing devices (for example, a desktop or server computer, tablet or notebook computer, personal data assistant, smart phone, a television or other display device with one or more computing devices embedded therein or attached thereto, or the like). In this regard, the blocks of FIG. 3 may be performed within the context of performing an online search in a search engine provided by the one or more computing devices.

In a first process 301, a search query and one or more criteria for organizing search results are received at a search engine interface (for example, a web page) displayed by a web browser. As described previously with regard to FIG. 2, the search engine interface includes an search query input 203 for receiving the search query and one or more sorting controls for 204 selecting the one or more criteria. In block 302, the search query and the one or more sorting criteria are sent to a search engine. The search engine interface may include code that, on receiving the search query and sorting criteria, facilitates the transmission of the received information to a back-end search engine.

In block 303, a group of search results are received from the search engine based on the search query. The search engine generates search results in response to user input into a text box at the search engine interface. The search results may be generated, for example, upon receiving text and a carriage return, receiving a selection of text (for example, a drop down) that is generated from text of a partial search term, or upon a predetermined time after text was received.

In block 304, the search results are organized based on the received sorting criteria. For example, search results may be comprised of a plurality of search result sets organized according to a first received criteria (for example, selected at sorting control 204), with a search result set including a listing of resources responsive to a subject matter of the search query (for example, web sites related to the subject matter of the search query) and organized according to one or more second criteria. The second criteria may be received with the first received criteria (for example, selected at sorting control 204) or predetermined by the search engine. In various implementations, the search result set includes a plurality of search result subsets, a search result subset including search results organized according to a third received criteria. The first received criteria may be a user-provided level of granularity that divides a group of search results returned in response to the search query, the group of search results comprising the search results of the returned search result sets. In this respect, the user-provided level of granularity may be a time-based granularity, the group of search results being divided by a time period associated with the time-based granularity, the returned search result sets being returned for respective time periods and ordered by time

Additionally or in the alternative, the one or more second criteria may include an instruction to sort the search result set according to a relevance of the search results to a user of the web browser (for example, as determined by the search engine under normal operating conditions). For a search result in the search result set, the relevance may be based on a degree of relationship between subject matter of the search result and a past browsing history of the user, based on a distance of the user from a geographic location associated with the search result, based on a difference between a current time and a time associated with a subject matter of the search result, or the like.

In block 305, a search result page is provided for display at a web browser, including the organized search results. In various implementations, the search result page is a web page that displays multiple search result sets, each set including a listing of resources (for example, web sites) related to a subject matter of the search query. In one implementation, the search result page includes a map, and at least one of the sorting criteria received from the web browser is a geographic level of granularity. In this respect, at least one of the search result sets returned to the browser is displayed graphically on a map, a search result set displayed for a respective geographic boundary determined by the level of geographic granularity.

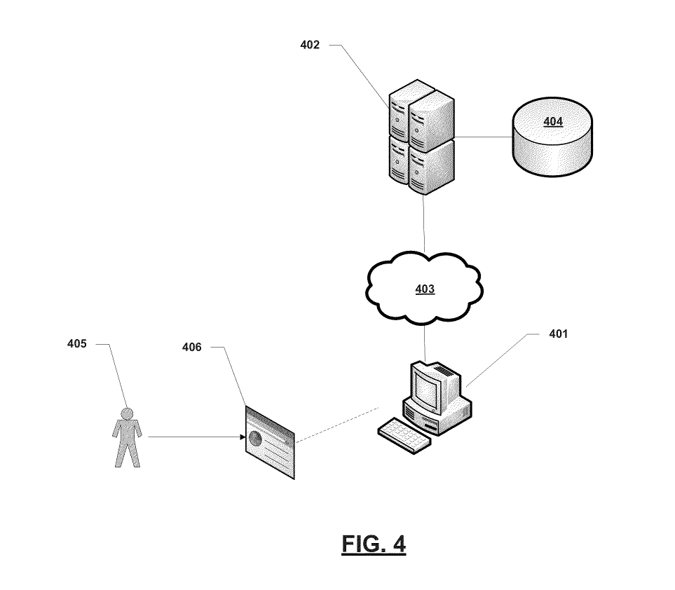

FIG. 4 is an example diagram illustrating server and database components of a system for organizing search results in response to a search query according to one aspect of the subject technology. A system compatible with the subject technology includes a computer-enabled device 401 (for example, a desktop or server computer, tablet or notebook computer, personal data assistant, smart phone, a television or other display device with one or more computing devices embedded therein or attached thereto, or the like) connected to one or more servers 402 via a network connection 403 (for example, the Internet, LAN/WAN, or the like). One or more servers 402 may include a search engine for generating search results in response to a search query. The one or more servers 402 may be connected to one or more storage locations 404 for storing search-related content. A user 405 may use device 401 to query the one or more servers 402. User 405 may interact with a user interface 406 (for example, a search interface) displayed by device 401. User interface 406 is configured with an input for receiving a search query and controls (for example, drop down lists, selection choices, text inputs or the like) for receiving sorting criteria, and code for transmitting information to a search engine web site on the one or more servers 402. In one aspect, the one or more servers 402 are operable to receive and respond to the search query received at user interface 406, and to generate one or more search results to be displayed at user interface 406.

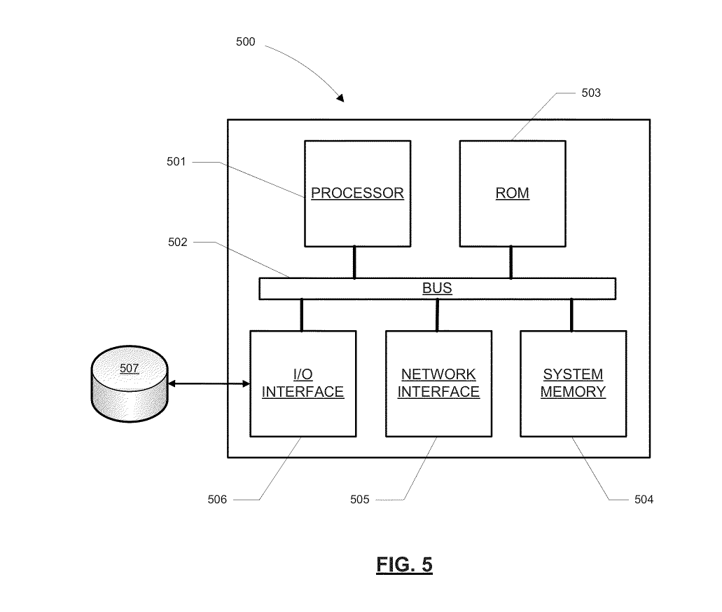

FIG. 5 is a diagram illustrating an example server system for organizing search results in response to a search query, including a processor and other internal components, according to one aspect of the subject technology. In some aspects, a computerized device 500 (for example, computing device 100, a search engine server, the like) includes several internal components such as a processor 501, a system bus 502, read-only memory 503, system memory 504, network interface 505, I/O interface 506, and the like. In one aspect, processor 501 may also be communication with a storage medium 507 (for example, a hard drive, database, or data cloud) via I/O interface 506. In some aspects, all of these elements of device 500 may be integrated into a single device. In other aspects, these elements may be configured as separate components.

Processor 501 may be configured to execute code or instructions to perform the operations and functionality described herein, manage request flow and address mappings, and to perform calculations and generate commands. Processor 501 is configured to monitor and control the operation of the components in server 500. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 501. Likewise, one or more sequences of instructions may be software stored and read from system memory 505, ROM 503, or received from a storage medium 507 (for example, via I/O interface 506). ROM 503, system memory 505, and storage medium 507 represent examples of machine or computer readable media on which instructions/code may be executable by processor 501. Machine or computer readable media may generally refer to any medium or media used to provide instructions to processor 501, including both volatile media, such as dynamic memory used for system memory 504 or for buffers within processor 501, and non-volatile media, such as electronic media, optical media, and magnetic media.

In some aspects, processor 501 is configured to communicate with one or more external devices (for example, via I/O interface 506). Processor 501 is further configured to read data stored in system memory 504 and/or storage medium 507 and to transfer the read data to the one or more external devices in response to a request from the one or more external devices. The read data may include one or more web pages and/or other software presentation to be rendered on the one or more external devices. The one or more external devices may include a computing system such as a personal computer, a server, a workstation, a laptop computer, PDA, smart phone, and the like.

In some aspects, system memory 504 represents volatile memory used to temporarily store data and information used to manage device 500. According to one aspect of the subject technology, system memory 504 is random access memory (RAM) such as double data rate (DDR) RAM. Other types of RAM also may be used to implement system memory 504. Memory 504 may be implemented using a single RAM module or multiple RAM modules. While system memory 504 is depicted as being part of device 500, those skilled in the art will recognize that system memory 504 may be separate from device 500 without departing from the scope of the subject technology. Alternatively, system memory 504 may be a non-volatile memory such as a magnetic disk, flash memory, peripheral SSD, and the like.

I/O interface 506 may be configured to be coupled to one or more external devices, to receive data from the one or more external devices and to send data to the one or more external devices. I/O interface 506 may include both electrical and physical connections for operably coupling I/O interface 506 to processor 501, for example, via the bus 502. I/O interface 506 is configured to communicate data, addresses, and control signals between the internal components attached to bus 502 (for example, processor 501) and one or more external devices (for example, a hard drive). I/O interface 506 may be configured to implement a standard interface, such as Serial-Attached SCSI (SAS), Fiber Channel interface, PCI Express (PCIe), SATA, USB, and the like. I/O interface 506 may be configured to implement only one interface. Alternatively, I/O interface 506 may be configured to implement multiple interfaces, which are individually selectable using a configuration parameter selected by a user or programmed at the time of assembly. I/O interface 506 may include one or more buffers for buffering transmissions between one or more external devices and bus 502 and/or the internal devices operably attached thereto.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method, comprising:
receiving a search query and one or more criteria for organizing search results; and
returning a plurality of search result sets organized according to a first received criteria, a respective search result set including a listing of resources responsive to a subject matter of the search query and organized according to one or more second criteria.

2. The computer-implemented method of claim 1, wherein the search result set includes a plurality of search result subsets, a search result subset including search results organized according to a third received criteria.

3. The computer-implemented method of claim 1, wherein the first received criteria is a user-provided level of granularity that divides a group of search results returned in response to the search query, the group of search results comprising the search results of the returned search result sets.

4. The computer-implemented method of claim 3, wherein the user-provided level of granularity is a time-based granularity, the group of search results being divided by a time period associated with the time-based granularity, the returned search result sets being returned for respective time periods and ordered by time.

5. The computer-implemented method of claim 1, wherein the second criteria is received with the first received criteria.

6. The computer-implemented method of claim 5, wherein the one or more second criteria comprises an instruction to sort the respective search result set according to a relevance of the search results to a user of a web browser.

7. The computer-implemented method of claim 6, wherein, for a search result in the respective search result set, the relevance is based on a degree of relationship between subject matter of the search result and a past browsing history of the user.

8. The computer-implemented method of claim 6, wherein, for a search result in the respective search result set, the relevance is based on a distance of the user from a geographic location associated with the search result.

9. The computer-implemented method of claim 6, wherein, for a search result in the respective search result set, the relevance is based on a difference between times associated with a subject matter of the search results.

10. The computer-implemented method of claim 1, wherein the first received criteria is a geographic level of granularity, the method further comprising:
displaying at least one of the plurality of search result sets graphically on a map, a search result set displayed for a respective geographic boundary determined by the level of geographic granularity.

11. The computer-implemented method of claim 1, further comprising:
determining a group of search results, the group of search results comprising the search results of the returned search result sets;
determining the one or more criteria based on the determined group of search results; and
providing the multiple criteria to a search engine.

12. The computer-implemented method of claim 1, further comprising:
providing a search interface to a user, the search interface including an input for receiving the search query and one or more controls for selecting the one or more criteria.

13. A machine-readable medium having machine-executable instructions stored thereon, which when executed by a machine or computer cause the machine or computer to perform a method, comprising:
sending a search query and one or more sorting criteria;
receiving a group of search results based on the search query;
organizing the search results based on the one or more sorting criteria; and
providing a search result page for display, including the organized search results.

14. The machine-readable medium of claim 13, further comprising:
receiving a coarse level of granularity and a fine level of granularity from the web browser; and
organizing the group of search results into search result sets ordered top-down from the coarse level of granularity to the fine level of a granularity.

15. The machine-readable medium of claim 13, further comprising:
receiving a first sorting criteria and a second sorting criteria;
dividing the group of search results into a plurality of search result sets based on the first sorting criteria; and
organizing a search result set based on the second sorting criteria.

16. The machine-readable medium of claim 15, further comprising:
comparing the search result set to a past browsing history, the search result set being organized based on a degree of relationship between subject matter of respective search results in the search result set and the past browsing history.

17. The machine-readable medium of claim 15, wherein the search result set is ordered based on a distance of the user from a geographic location associated with the search result.

18. The machine-readable medium of claim 15, wherein the search result set is ordered based on a difference between a current time and a time associated with a subject matter of the search result.

19. The machine-readable medium of claim 15, wherein the first received criteria is a geographic granularity, the method further comprising:
providing the plurality of search result sets for graphical display on a map, a search result set displayed for a respective geographic boundary determined by a level of the geographic granularity.

20. A system, comprising:
a processor; and
a memory including instructions that, when executed by the processor, causes the processor to:
receive a search query and sorting criteria, the sorting criteria comprising a coarse level of granularity and a fine level of granularity;
receive search results based on the search query;
organize the search results based on the multiple sorting criteria so that the search results are ordered top-down from the coarse level of granularity to the fine level of a granularity; and
provide a search result page for display, including the organized search results.
